(19) United States
(12) Patent Application Publication
(10) Pub. No.: US 2005/0222980 A1
(43) Pub. Date: Oct. 6, 2005

(54) Fragment elimination

(75) Inventor: Evan C. Lee, Redwood City, CA (US)

Correspondence Address: FAY, SHARPE, FAGAN, MINNICH & McKEE, LLP;Michael E. Hudzinski, Seventh Floor, 1100 Superior Avenue, Cleveland, OH, 44114, US

(73) Assignee: International Business Machines Corporation

(21) Appl. No.: 10/815,056

(22) Filed: Mar. 31, 2004

(51) Int. Cl. G06F 7/00

(52) U.S. Cl. 707/3

(57) ABSTRACT

A database is fragmented into a plurality of database fragments using a plurality of fragmentation expressions. Each fragmentation expression corresponds to a database fragment and includes a boolean combination of one or more comparison-predicates. Each comparison-predicate defines a range of a fragmentation dimension basis function of one or more database fields. A database query is processed against the database by: (i) resolving a data selection expression of the database query into a boolean combination of fragment selection comparison-predicates each defining a range of one of the fragmentation dimension basis functions; (ii) identifying one or more eliminated database fragments based on the boolean combination of fragment selection comparison-predicates and the fragmentation scheme; and (iii) processing the database query against database fragments other than the eliminated database fragments.

### BACKGROUND OF THE INVENTION

1. Field of the Invention

The following is directed toward the information gathering, storage, and manipulation arts. It is described with particular reference to relational database systems; however, the following will also find application in other types of database systems and data storage systems such as hierarchal databases, web databases, and the like.

2. Description of the Prior Art

Databases are typically used to collect and manage large quantities of data. In a relational database, the data is stored in a format in which each data entry or record includes one or more fields of information. Commonly, such a data structure is thought of as being in a tabular format, in which the information fields correspond to table columns and each data entry or record corresponds to a table row.

To access the database, users typically construct database queries that access selected data specified by the query. For example, if the database includes a date field or column, the user may formulate a query that selects data entries for processing which fall within a certain range of dates. In some databases, a version of the structured query language (SQL) is used to formulate and process queries.

As information processing expands, databases are becoming massive. Databases of national or global corporations, governments, financial institutions, or other large entities may receive data entries from hundreds, thousands, or more users via the Internet, a local area network, or the like. Some of these “users” may be automated programs or systems that input large quantities of automatically generated data into the database. Managing such large databases is difficult.

One technique for more efficiently managing databases is database fragmentation, some examples of which are described in Zou, U.S. Pat. No. 6,681,218 and in the companion international publication WO 01/33436 A1. Generally, data fragmentation involves dividing the data up amongst a plurality of database fragments, sub-divisions, partitions, or the like. Each database fragment operates as a substantially independent database against which queries can be processed, thus enabling a certain degree of parallel processing capability. The data entries or records can be divided up amongst the database fragments based on a variety of fragmentation criteria, such as round robin fragmentation, hash-based fragmentation, and expression or range based fragmentation. In expression or range based fragmentation techniques, the database fragment into which a new data record is inserted is determined based on the content of one or more fields or columns. As just one example, if the database includes a year field, then a first database fragment may store data entries for year 2004, a second database fragment may store data entries for years 2002-2003, a third database fragment may store data entries for years 1999-2001, and a fourth database fragment may store data entries for years earlier than 1999. The data distribution scheme is commonly called the fragmentation scheme.

Moreover, a technique commonly known as fragment elimination can be performed in conjunction with a fragmented database to further improve query execution performance and to save system resources by avoiding redundant processing. In fragment elimination, data selection criteria of the database query are compared with the fragmentation scheme prior to query execution. Based on this comparison, it may be determined that one or more database fragments cannot contain any records that satisfy the query data selection criteria, and thus the query is not processed against those database fragments. Using the above year field example, if the database query includes a data selection criterion 2000≦year≦2002, then the first and fourth database fragments cannot contain any data entries or records that meet this selection criterion, and so the query is only processed against the second and third database fragments.

Fragmented databases and fragment elimination provide substantial improvement in database query efficiency and speed. However, existing database fragmentation and fragment elimination techniques have certain limitations. Existing fragment elimination techniques provide limited fragment elimination optimization. Typically fragment elimination is limited to database field selection criteria that identify a range of a database field. Such database field based fragment elimination techniques do not provide fragment elimination when the data selection expression of the database query is more complex than simply identifying ranges for database fields or columns.

It is thus desirable to provide improved methods, systems, and articles of manufacture pertaining to fragmented databases.

### BRIEF SUMMARY

In accordance with one aspect, a method is disclosed. A database is fragmented into a plurality of database fragments using a plurality of fragmentation expressions. Each fragmentation expression corresponds to a database fragment and includes a boolean combination of one or more comparison-predicates. Each comparison-predicate defines a range of a fragmentation dimension basis function of one or more database fields. A database query is processed against the database fragments of the database.

In accordance with another aspect, a fragmented database is disclosed. A fragmentation scheme includes: (i) one or more fragmentation dimension basis functions wherein each fragmentation dimension basis function depends upon one or more database fields; and (ii) a plurality of fragmentation expressions. Each fragmentation expression is defined by a boolean combination of comparison-predicates wherein each comparison-predicate defines a range of one of the fragmentation dimension basis functions. A plurality of database fragments are included, each database fragment containing data satisfying a corresponding one of the plurality of fragmentation expressions.

In accordance with yet another aspect, a storage medium is disclosed which encodes program code for performing database functions. The program code includes: program code for constructing a fragmented database having a fragmentation scheme constructed using fragmentation dimension basis functions, each fragmentation dimension basis function depending upon at least one database field; and program code for inserting a new record into the fragmented database, the inserting including (i) computing values of the fragmentation dimension basis functions using fields of the new record, (ii) selecting a target database fragment based on the fragmentation scheme and the computed values of the fragmentation dimension basis functions, and (iii) inserting the new record into the target database fragment.

### BRIEF DESCRIPTION OF THE DRAWINGS

The invention may take physical form in certain parts and processes and arrangements of parts and processes, the preferred embodiments of which will be described in detail in this specification and illustrated in the accompanying drawings hereof. It is to be understood that both the foregoing general description and the following detailed description are examples and explanatory only, and are not to be construed as restricting the invention as claimed.

FIG. 1 shows a diagrammatic representation of a fragmented database employing a fragmentation scheme based on fragmentation dimension basis functions.

FIG. 2 illustrates an example fragmentation dimension basis function which depends upon two database fields.

FIG. 3 illustrates another example fragmentation dimension basis function which is a monotonic extraction function of a database field.

FIG. 4 shows a diagrammatic representation of a database query processor for applying a database query to the fragmented database of FIG. 1.

FIG. 5 shows a more detailed diagrammatic representation of the fragment selection comparison-predicates processor of FIG. 4.

FIG. 6 shows a diagrammatic representation of a processor for performing a row insert operation inserting a new row into the fragmented database of FIG. 1.

### DETAILED DESCRIPTION OF THE INVENTION

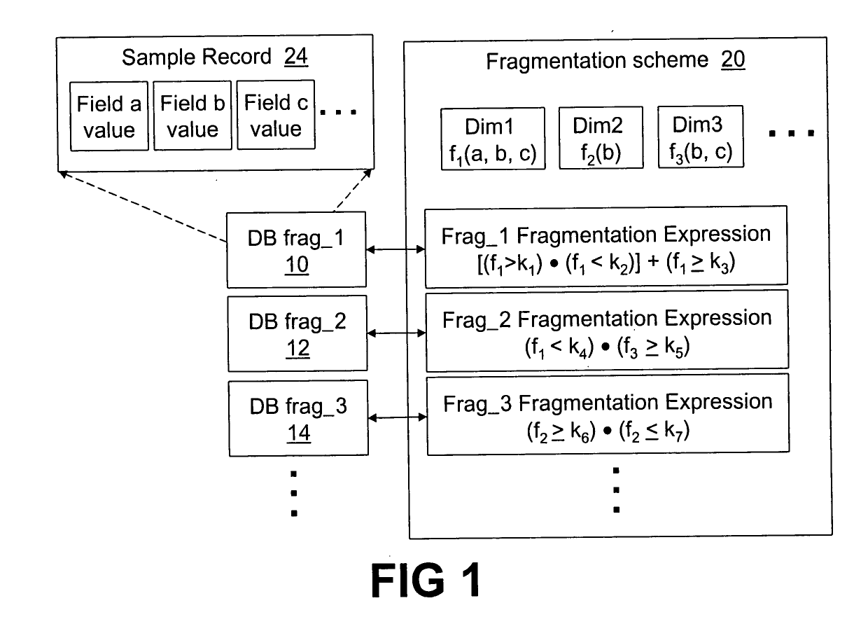

With reference to FIG. 1, a fragmented database includes a plurality of database segments, partitions, sub-divisions, or fragments 10, 12, 14 organized in accordance with a fragmentation scheme 20. Three database fragments 10, 12, 14 are illustrated; however, substantially any number of database fragments can be included. In FIG. 1, where a few example elements are illustrated but the number of elements is arbitrary, such as is the case for the database fragments 10, 12, 14, an ellipsis (“ . . . ”) is included in FIG. 1 to indicate that one, two, the illustrated number, or more of such elements can be included. Each database fragment 10, 12, 14 is a substantially self-contained database including internal organizational schema, data storage, and so forth. In some embodiments each database fragment 10, 12, 14 is stored and managed by a separate server or computer, which may be located together or distributed geographically and connected by a network. Such a distributed arrangement advantageously enables a query to be applied simultaneously or in parallel to the fragments 10, 12, 14 to improve query processing efficiency. However, it is also contemplated to have some or all of the database fragments 10, 12, 14 reside on the same server or computer.

Each database fragment 10, 12, 14 contains data entries or records, in which each data entry or record has one or, more typically, a plurality of data fields. Commonly, this data organization is described or thought of in terms of a tabular notation, in which each data entry or record is referred to as a row, and each data field is referred to as a column. Each row has identical columns or data fields, although the value stored in a column is generally different for each record or row. Moreover, each of the database fragments 10, 12, 14 has the same columns or data fields. In the example database illustrated in FIG. 1, the database includes fields designated “a”, “b”, “c”, . . . . As just one example, field “a” may represent a Datetime value. The value of each field is generally different for each record, and corresponds to the particular data stored in that record. While tabular notation employing terms such as rows and columns will be used herein, it will be appreciated that this tabular notation is one of convenience; the data may be arranged and stored in a variety of configurations.

While the database fragments 10, 12, 14 are substantially self-contained, access to the fragmented database is typically through a single unitary interface which internally routes database operations such as queries, row insert or update operations, or the like to the appropriate database fragment or fragments. The fragmentation scheme 20 is referenced to determine which data are stored in which database fragment 10, 12, 14. The user, application program, or other entity accessing or otherwise interacting with the database generally does not need to have knowledge of the fragmentation scheme 20. In the described embodiments, users access the database by formulating database queries in a structured query language (SQL). However, other query formulation methodologies or syntaxes can be employed. For example, queries can be constructed using processes embodied by a compiled C++ program which employs a query syntax other than an SQL type syntax. Moreover, it is to be appreciated that the “users” may include non-human users, such as application programs or other software, automated programs, external servers, or the like, that access the database.

The fragmentation scheme 20 is constructed in terms of fragmentation dimension basis functions. In the example embodiment, the fragmentation scheme employs three fragmentation dimensions identified as “Dim1”, “Dim2”, “Dim3”. However, the number of fragmentation dimensions is arbitrary can be one, two, three, four, or more. Each fragmentation dimension is defined by a fragmentation dimension basis function that depends upon one or more of the database fields. In the specific example shown in FIG. 1, fragmentation dimension “Dim1” is defined by fragmentation dimension basis function f₁(a,b,c) which depends upon database fields a, b, and c. Fragmentation dimension “Dim2” is defined by fragmentation dimension basis function f₂(b) which depends only upon database field b. Fragmentation dimension “Dim3” is defined by fragmentation dimension basis function f₃(b,c) which depends upon database fields b and c. In some embodiments there may be only a single fragmentation dimension defined by a corresponding fragmentation dimension basis function.

In the simplest case, a fragmentation dimension basis function is an identity function depending upon a single field, such as for example f₂(b)=b. However, the fragmentation dimension basis functions can be more complex. For example, the fragmentation dimension “Dim3” may be defined by the basis function f₃(b,c)=b×c where “×” indicates a product of the values of database fields b and c. Moreover, a dimension can be defined as an extraction applied to a complex data type, such as for example f₂(b)=YEAR(b) where b is a database field of the Datetime data type and YEAR( ) is an extraction transform which extracts the year component of a value of the Datetime data type.

The fragmentation dimension basis functions are used in constructing fragmentation expressions that specify which records are disposed in which of the database fragments 10, 12, 14. In one embodiment, each fragmentation expression is defined by a boolean combination of comparison-predicates, in which each comparison-predicate defines a range of a fragmentation dimension basis function. In example FIG. 1, the database fragment 10 is associated with the fragmentation expression: [(f₁>k₁)∘(f₁<k₂)]+(f₁≧k₃), where k₁, k₂, k₃ are constants and f₁ is the fragmentation dimension basis function for “Dim1”. This example fragmentation expression includes three comparison-predicates: (i) f₁>k₁, (ii) f₁<k₂, and (iii) (f₁≧k₃). These three comparison-predicates are combined using the boolean disjunction operator “+” which represents an “OR” combination, the boolean conjunction operator “∘” which represents an “AND” combination, and by associations “( )” and “[ ]”.

It will be recognized that each comparison-predicate represents a one-dimensional range of the corresponding fragmentation dimension basis function. Thus, the comparison-predicate f₁>k₁ is equivalent to the range (k₁,∞); the comparison-predicate f₁<k₂ is equivalent to the range (−∞,k₂); and the comparison-predicate f₁≧k₃ is equivalent to the range [k₃,∞). Moreover, the conjunction [(f₁>k₁)∘(f₁<k₂)] can alternatively be viewed as a single complex comparison-predicate equivalent to the range (k₁,k₂) of the fragmentation dimension basis function f₁.

A simple comparison-predicate refers to an expression having a comparison operator comparing a function (not necessarily one of the fragmentation dimension basis functions) with a constant value. The comparison operator can be an equality “=”, an inclusive inequality “≦”, “≧”, an exclusive inequality “<”, “>”, or the like. A complex comparison-predicate can be written as a boolean combination of simple comparison-predicates. Thus, for example, the complex comparison-predicate (k₁<f₁<k₂) can be written as a conjunction of simple comparison-predicates as [(f₁>k₁)∘(f₁<k₂)]. Any comparison-predicate is equivalent to a range, as noted above using the comparison-predicates of the fragmentation expression of frag_{—}1 10 as examples. Complex comparison-predicates may define a broken range. For example, the complex predicate [(k₁<f₁<k₂)∘(k₃<f<k₄)] where k₁<k₂<k₃<k₄ represents the broken range (k₁,k₂)∩(k₃,k₄) where “∩” represents a union of ranges.

The fragmentation expression for the database fragment 12 is: (f<k₄)∘(f₃>k₅) where f₁, f₃ are basis functions and k₄, k₅ are constants. The fragmentation expression for the database fragment 14 is: (f₂≧k₆)∘(f₁≦k₇) where f₂ is a basis function and k₆, k₇ are constants. It is to be appreciated that the constants can be Datetime data type constants, numeric constants, character or string constants, or constants of other data types. The comparison operator of the comparison-predicate may impose an implicit data type transformation; for example, if the left-hand side is a floating point function and the right-hand side is an integer constant, appropriate implicit data type transformation is ordinarily performed to reconcile the two different data types. Again, it is emphasized that the fragmentation expressions written in FIG. 1 are examples only; the fragmentation expressions can in general be any boolean combination of simple or complex comparison-predicates in which each comparison-predicate defines a range of one of the basis functions.

The fragmentation expression corresponding to each database fragment identifies which kinds of data are stored in that database fragment. For example, the database fragment 10 stores only records having f₁ in the range (k₁,k₂) or in the range [k₃,∞). If k₂<k₃ then a discontinuous range is defined. If k₂>k₃ then the fragmentation expression for database fragment 10 is not in the simplest possible form, but nonetheless can be used as the fragmentation expression. Considering the example sample record 24 shown in FIG. 1, the value of fragmentation dimension basis function f₁(a,b,c) computed for the field values of the sample record 24 must lie in the range (k₁,k₂) or in the range [k₃,∞), or in both ranges, so that the record 24 satisfies the fragmentation expression of database fragment 10.

A fragmentation expression can be multi-dimensional in that it can include a boolean combination of comparison-predicates depending upon different fragmentation dimension basis functions. For example, the database fragment 12 has the fragmentation expression: (f₁<k₄)●(f₃≧k₅) which includes a first comparison-predicate involving basis function f₁(a,b,c) and a second comparison-predicate involving basis function f₃(b,c).

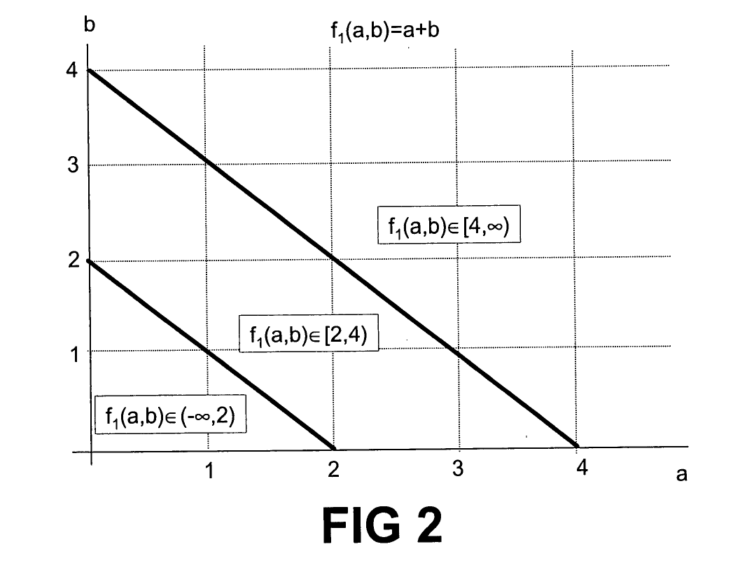

With reference to FIG. 2, an example of a fragmentation dimension basis function designated f, which is multi-dimensional is illustrated. The basis function f₁(a,b)=a+b where a and b are database field or column values of numeric data type and “+” here represents an arithmetic sum operator. FIG. 2 illustrates fragmentation based on the basis function f₁(a,b)=a+b. The fragmentation scheme illustrated in FIG. 2 is expressed algebraically as:
Frag1: f_{1 (}a,b)<2
Frag2: (f₁(a,b)≧2)●(f₁(a,b)≦4)
Frag3: f_{1 (}a,b)>4 (1).

Equation (1) represents the fragmentation expressions using simple comparison-predicates each represented by a comparison operator comparing the value of f₁ with a constant. The fragmentation scheme illustrated in FIG. 2 can also be represented by the following equivalent ranges (also labeled in FIG. 2):
Frag1: f_{1 (}a,b)ε(∞,2)
Frag2: f₁(a,b)ε[2,4)
Frag3: f_{1 (}a,b)ε[4,∞) (2)

It will be appreciated that Equation (1) and Equation (2) are equivalent; each represents the same boolean combination of comparison-predicates. In Equation (1), the comparison-predicates are represented by algebraic inequalities (or, in the case of Frag2, by a boolean combination of algebraic inequalities), while in Equation (2) the comparison-predicates are represented as ranges. The manipulations of comparison-predicates described herein can be performed in either an algebraic or a range representations, or in a combination thereof.

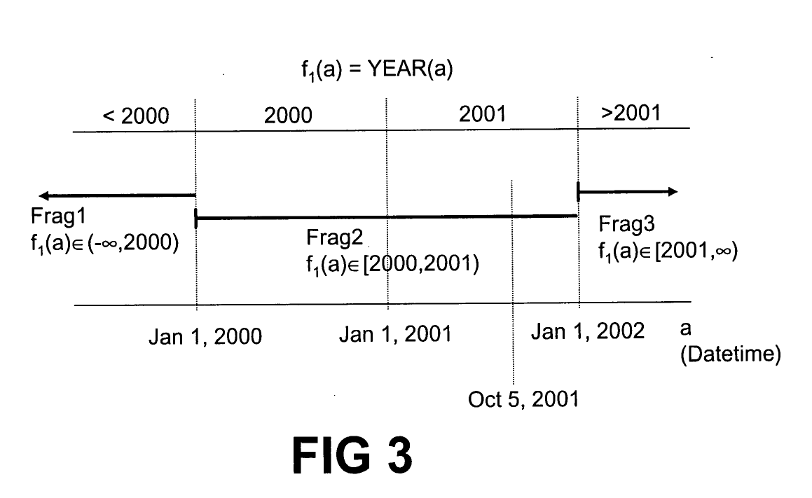

With reference to FIG. 3, another example of a fragmentation dimension basis function is described. Here, the database field “a” is assumed to contain Datetime values. The fragmentation dimension basis function is f₁(a)=YEAR(a), where YEAR( ) is an extraction function that extracts the year component from a Datetime argument. It will be appreciated that YEAR(a) is a more coarse time dimension having a resolution of years as compared with the Datetime value a which has a resolution of a fraction of a day. The fragmentation scheme illustrated in FIG. 3 can be expressed algebraically as:
Frag1: f_{1 (}a)<2000
Frag2: f_{1 (}a)≧2000●f_{1 (}a)<2001
Frag3: f_{1 (}a)≧2001 (3).

The fragmentation expression for Frag2 is given in Equation (3) as a boolean combination of simple comparison-predicates. This fragmentation expression can alternatively be expressed algebraically as a single complex comparison-predicate as:
Frag2: 2000≦f₁(a)<2001 (4).

The fragmentation scheme illustrated in FIG. 3 can also be expressed in terms of ranges (labeled in FIG. 3) as:
Frag1: f_{1 (}a)ε(−∞, 2000)
Frag2: f_{1 (}a)ε[2000, 2001)
Frag3: f_{1 (}a)ε[2001, ∞) (5).

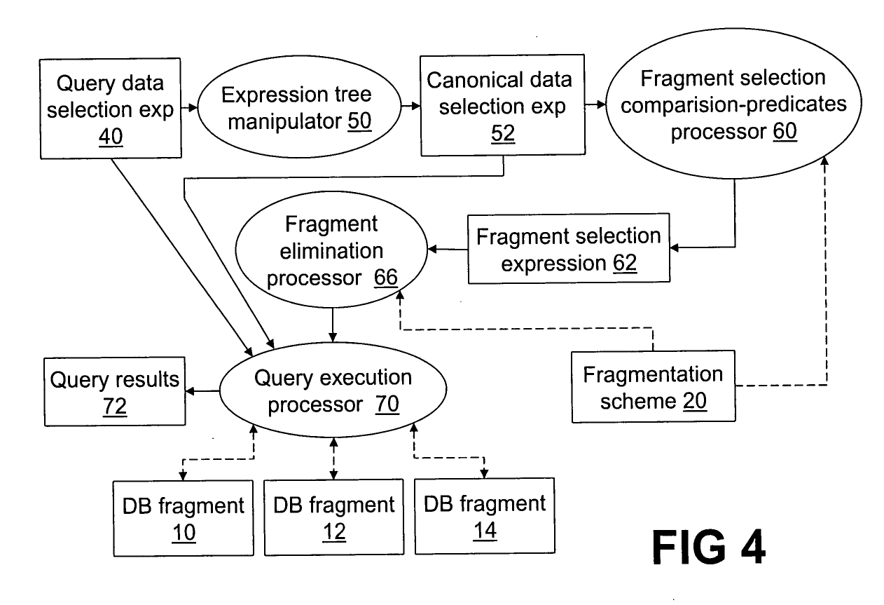

With reference to FIG. 4, the fragmentation scheme 20 based on one or more fragmentation dimension basis functions can be employed in performing fragment elimination during execution of a query 40 which includes a data selection expression. The query 40 is described herein as an SQL query employing a boolean combination of comparison-predicates as the data selection expression; however, it will be appreciated that database queries using other syntactical formulations can be similarly processed. In some such other syntactical formulations, it is contemplated that the data selection expression may be expressed in terms of ranges.

The data selection expression of the query 40 is input into an expression tree manipulator 50 that converts the data selection expression into an expression tree format and manipulates the expression tree representation of the data selection expression into a canonical or standardized data selection expression 52 that includes a boolean combination of one or more comparison-predicates each depending upon one or more of the fragmentation dimension basis functions. The expression tree manipulator 50 may transform complex comparison-predicates of the form a<f<b (where a, b are constants and f is an expression involving one or more database fields) into a boolean combination of simple comparison-predicates of the form (f>a)∘(f<b), may transform a comparison such as f>g (in which f and g are both expressions involving one or more database fields) into a form comparing an expression with a constant (for example, converting f>g into (f−g)>0 by subtracting g from the left-hand and right-hand sides of the comparison-predicate), or so forth. The canonical data selection expression is equivalent to the original data selection expression of the query 40, but is merely manipulated into a more convenient form for processing. In some embodiments, it is contemplated to omit such conversion processing into a canonical form; in those embodiments, implementation of the subsequent processing may be more complicated due to the lack of a standardized form.

With continuing reference to FIG. 4, a fragment selection comparison-predicates processor 60 constructs a fragment selection expression 62 based on the canonical data selection expression 52 and the fragmentation scheme 20. Typically, the fragment selection expression 62 is a boolean combination of fragment selection comparison-predicates, in which each fragment selection comparison-predicate is derived from a comparison-predicate of the canonical data selection expression 52. Each fragment selection comparison-predicate specifies a one-dimensional (possibly discontinuous) range of one of the fragmentation dimension basis functions. Each one-dimensional fragment selection range identifies a range of values for that fragmentation dimension basis function that at least includes the range of the corresponding comparison-predicate of the data selection expression of the query 40.

A fragment elimination processor 66 performs fragment elimination based on comparison of the fragment selection expression 62 with the fragmentation scheme 20. The fragment elimination identifies one or more database fragments that cannot possibly contain data satisfying the data selection expression of the query 40. A query execution processor 70 processes the query data selection expression 40 against the database fragments other than the eliminated database fragments, and combines the results of the query processing from the various database fragments into query results 72.

In one embodiment, the fragment elimination processor 66 performs the fragment elimination as follows. Each comparison-predicate of the fragment selection expression 62 is compared with a corresponding comparison-predicate of the fragmentation expression for that database fragment. By “corresponding”, it is meant that both the fragment selection comparison-predicate and the fragment expression comparison-predicate define one-dimensional (possibly discontinuous) ranges of the same fragmentation dimension basis function. If the comparison indicates some overlap of the range of the basis function defined by the comparison-predicate of the fragment section expression 62 and the range of the basis function defined by the corresponding comparison-predicate of the fragmentation expression, then a selection bit for that comparison-predicate is set to binary one. If there is no overlap, the comparison-predicate is set to binary zero. This is done for each comparison-predicate of the fragment selection expression 62.

The selection bits for the various comparison-predicates are then combined in accordance with the boolean combination of comparison-predicates of the fragment selection expression 62. If the boolean combination of the fragment selection expression 62 includes a disjunction (i.e., boolean “or” operator) of two comparison-predicates, then the selection bits of the comparison-predicates on the left- and right-hand sides of the “or” are combined using boolean “or” operation. Similarly, if the boolean combination of the fragment selection expression 62 includes a conjunction (i.e., boolean “and” operator) of two comparison-predicates, then the selection bits of the comparison-predicates on the left- and right-hand sides of the “and” are combined using boolean “and” operation. Such conjunctive or disjunctive boolean combining can be repeated to implement a plurality of boolean conjunctions and disjunctions of the fragment selection expression 62. Moreover, those skilled in the art recognize that more complex binary operators, such as exclusive or “xor”, nand, nor, and the like, always can be converted into a boolean combination involving only conjunctions and disjunctions (i.e., “and” and “or”), and can therefore be implemented as just described.

The final result of the boolean combining is a binary one or a binary zero. A binary one indicates that the corresponding database fragment may include some data satisfying the data selection expression of the query 40; that fragment thus cannot be eliminated from the query processing. A binary zero indicates that the database fragment cannot contain any data satisfying the data selection expression of the query 40, and thus can be eliminated from the query processing. The above fragment elimination process is repeated for each database fragment. That is, the fragment selection expression 62 is compared in the above manner with the fragmentation expression of each database fragment to determine whether each database fragment can be eliminated from the query processing.

The operation of the fragment elimination processor 66 described above is an example only. Those skilled in the art can readily employ other methods for implementing the boolean combining and comparing. For example, a boolean disjunction can be processed first to produce a boolean combination of ranges for the basis functions, which are then compared against the fragmentation scheme 20 to identify fragments that can be eliminated. Moreover, the boolean polarity can be reversed by introducing trivial changes in the processing, so that binary one can represent an eliminated fragment while binary zero represents a retained fragment.

The fragment selection comparison-predicates processor 60 produces the fragment selection expression 62 which has the following properties: (i) the fragment selection expression 62 is written in terms of the fragmentation dimension basis functions; and (ii) the fragment selection expression 62 is satisfied by any database record which also satisfies the data selection expression of the query 40. Note that property (ii) is one-directional only: the converse, that any database record satisfying the data selection expression also satisfies the fragment selection expression 62, is not necessarily true. Property (i) enables convenient comparison of the fragment selection expression with the fragmentation expressions which are boolean combinations of the fragmentation dimension basis functions. Property (ii) ensures that no records satisfying the data selection expression are inadvertently missed by improperly eliminating a database fragment.

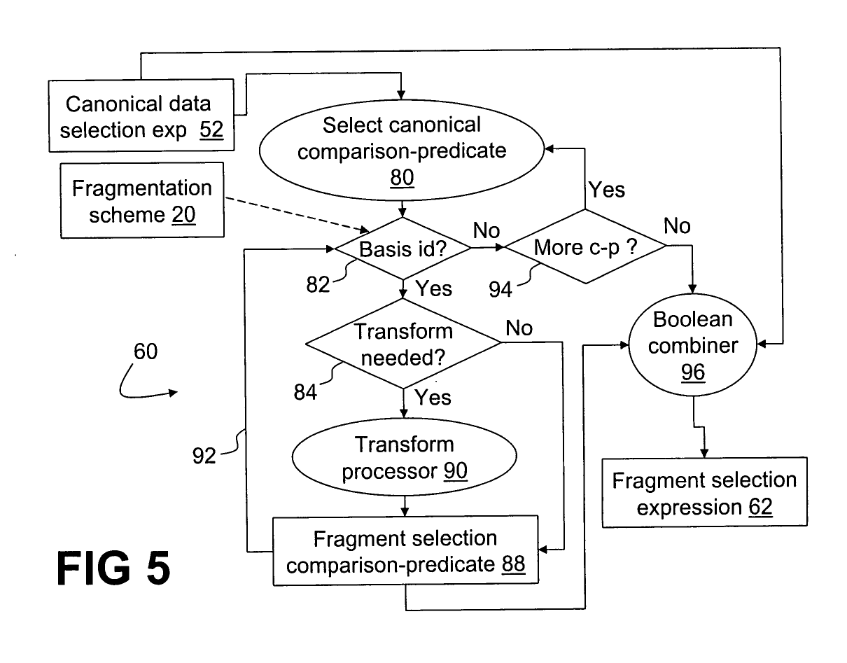

With reference to FIG. 5, in one suitable embodiment of the fragment selection comparison-predicates processor 60, a selector 80 identifies one of the comparison-predicates of the canonical data selection expression 52 for processing. The identified comparison-predicate is preferably a simple comparison-predicate including a comparison operator, such as less than, greater than, less than-or-equal, greater than-or-equal, equal, or the like, which compares a candidate function with a constant value. Note that complex comparison-predicates such as a<f<b (where a, b are constants and f is an expression or function involving at least one database field) can always be converted into a boolean combination of simple predicates such as (f>a)∘(f<b). Similarly, comparison-predicates of the form f>g (where f, g are each an expression or function involving at least one database field) can always be converted into a comparison of an expression or function with a constant, for example by subtracting g from both sides of the comparison-predicate. Using such manipulations, the expression tree manipulator 50 (see FIG. 4) preferably generates the canonical data selection expression 52 as a boolean combination of simple comparison-predicates each including a comparison operator comparing a candidate expression or function involving one or more database fields with a constant. However, it is also contemplated to perform the fragment selection comparison-predicate determinations based on a data selection expression written in terms of complex comparison-predicates.

The comparison-predicate selected by the selector 80 is analyzed by a decision processor 82 examines the candidate expression of the identified comparison-predicate and attempts to relate it to one of the fragmentation dimension basis functions. In the simplest case, the candidate expression is equivalent to one of the basis functions. As just one example, the basis function may be f₁=YEAR(a) as shown in FIG. 3, and the selected comparison-predicate may be YEAR(a)>2000. In this case, the candidate function of the selected comparison-predicate is YEAR(a), is exactly equivalent to basis function f₁.

In other cases, the candidate function not be exactly equivalent to a basis function but may be transformable into the basis function. As just one example, the basis function may be f₁(a)=YEAR(a) as shown in FIG. 3, and the selected comparison-predicate may be a>Jun. 1, 2000. In this case, the candidate function of the selected comparison-predicate is “a”, which is transformable into the basis function f₁ (a) by applying extraction function YEAR( ).

Assuming the decision processor 82 identifies the candidate function of the selected comparison-predicate with one of the basis functions, a second decision processor 84 determines whether a transform is needed to convert the comparison-predicate into a fragment selection comparison-predicate involving one of the basis functions. If no transform is needed (i.e., if the candidate function of the identified comparison-predicate is algebraically equivalent to the basis function) then the identified comparison-predicate is selected as one of the fragment selection comparison-predicates 88.

On the other hand, if a transform is needed to convert the candidate function into the identified basis function, then a transform processor 90 applies the appropriate transform to the candidate function and to the constant value of the selected comparison-predicate. To ensure that the transformed function is single-valued, the transform processor 90 applies a monotonic transform, such as monotonically increasing or monotonically decreasing. (As used herein, “monotonically increasing” means “not decreasing”, and similarly “monotonically decreasing” means “not increasing”. For example, the YEAR( ) extraction is considered herein to be a monotonically increasing in that as the Datetime argument of the YEAR( ) extraction increases, the output value of the YEAR( ) extraction generally increases. Over some intervals, YEAR( ) is flat: for example, between Jan. 2, 2001 and Nov. 2, 2001 the YEAR( ) extraction yields the flat value 2001. However, the YEAR( ) extraction never decreases as the Datetime argument increases. Hence, YEAR( ) is considered herein to be a monotonically increasing function.) Moreover, in some circumstances, such as where the transform increases granularity, an adjustment of the transformed constant or a comparison operator substitution is made by the transform processor 90 to account for a reversal of function slope or to ensure that the range specified by the transformed comparison-predicate at least includes the range specified by the selected comparison-predicate.

It will be appreciated that the identified comparison-predicate of the canonical data selection expression 52 may correspond to more than one of the basis functions. For example, if the identified comparison-predicate is a>Jan. 1, 2000, and the fragmentation scheme includes a first fragment dimension basis function f₁(a)=a and a second dimension basis function f₂(a)=YEAR(a), then the selected comparison-predicate a>Jan. 1, 2000 can provide a first fragment selection comparison-predicate relating to the first basis function f₁(a)=(a), and can also provide a second fragment selection comparison-predicate relating to the second basis function f₂(a)=YEAR(a). To address such a possibility, an iteration operator 92 (indicated by a feedback pathway 92 in FIG. 5) returns to the decision processor 82 to determine whether or not another fragmentation dimension basis function corresponds to the candidate function of the identified comparison-predicate.

Once the decision processor 82 determines that no additional fragment selection comparison-predicates can be derived from the identified comparison-predicate, a decision processor 94 determines whether there are additional comparison-predicates of the canonical data selection expression 52. If there are additional comparison-predicates, the selector 80 identifies another comparison-predicate of the canonical data selection expression 52 for processing. In this manner the fragment selection comparison-predicates processor 60 iteratively works through the comparison-predicates of the canonical data selection expression 52.

Once the decision processor 94 indicates that all comparison-predicates of the canonical data selection expression 52 have been processed, a boolean combiner 96 combines the fragment selection comparison-predicates to produce the fragment selection expression 62. Typically, the boolean combination corresponds to the boolean combination of the source data selection comparison-predicates forming the canonical data selection expression 52.

The example fragment selection comparison-predicates processor 60 operates on algebraic expressions, for example through the use of expression tree manipulations. In other contemplated embodiments, the data selection comparison-predicates are input to the fragment selection comparison-predicates processor as a boolean combination of ranges. Those skilled in the art can readily perform the algebraic manipulations particularly described herein with reference to FIG. 5 as range manipulations.

Derivation of a fragment selection expression from the query data selection expression is not always possible. For example, consider the data selection expression a/b<3 where a and b are database fields. If none of the fragmentation dimension basis functions correspond to a/b or a derivation thereof, then there may be no straightforward way to derive a fragment selection expression written in terms of the fragmentation dimension basis functions from the data selection expression a/b<3. In such a case, the fragment elimination processor 66 preferably returns no eliminated fragments, so as to ensure that the query execution processor 70 processes the query 40 against all the database fragments 10, 12, 14.

The fragment elimination process is described below in more detail using specific examples. These examples are illustrative only, and are not intended to limit the invention. As a first example, consider the fragmentation basis function f₁(a)=YEAR(a) illustrated in FIG. 3, and a data selection expression of the query 40 including the comparison predicate:
a<Oct. 5, 2001 (6).

This data selection comparison-predicate includes a comparison operator “<”, an expression “a” depending upon a database field “a” (identity function), and a constant value “Oct. 5, 2001”. The expression “a” is identified by the basis function identifier 82 as corresponding to the basis function f₁(a). However, expression “a” differs from the basis function f₁ (a) in that the expression “a” does not incorporate the extraction operator YEAR( ).

To address this situation, the transform processor 90 performs a suitable re-dimensioning of the expression “a” by applying the YEAR( ) extraction function to both sides of the comparison operator “<” of the data selection comparison-predicate of Equation (6). That is, the transform processor 90 applies the YEAR( ) extraction function to the expression “a” and to the constant “Oct. 5, 2001”, to produce the following fragment selection comparison-predicate:
YEAR(a)≦2001 (7).

It will be noted that in Equation (7), the exclusive “less than” inequality (“<”) comparison operator of Equation (6) has been replaced by an inclusive “less than or equal to” inequality (“≦”) comparison operator. This change is appropriate because the YEAR( ) extraction function produces a coarser dimensioning versus the Datetime dimension of the database field “a”. Without substituting the inclusive inequality, the dates between Jan. 1, 2001 and Oct. 4, 2001, which satisfy the data selection expression a<Oct. 5, 2001, would not be included in the fragment selection expression.

More generally, to ensure that no relevant database records are lost by the fragment elimination, the fragment selection comparison-predicates should each have a range which includes at least the range of the comparison-predicate of the data selection expression from which the fragment selection comparison-predicate is derived. Hence, when the transform processor 90 substitutes a more coarse dimension for a finer dimension of a comparison-predicate of the fragment selection expression, any exclusive inequality comparison operator should be replaced by an inclusive inequality comparison operator to ensure that the range of the fragment selection comparison-predicate at least includes the entire range of the data selection comparison-predicate.

In contrast, when the conversion is in the direction of reduced coarseness, such an inequality correction is generally not needed. For example, consider an example in which the fragmentation scheme includes a fragmentation dimension basis function f₁(a)=a where “a” is a Datetime database field. If the data selection expression of the query 40 includes the comparison-predicate:
YEAR(a)<2001 (8),

then the data selection expression of Equation (8) is identified by the basis identifier 82 as being close to the fragmentation dimension basis function f₁(a)=a, except that candidate function YEAR(a) is in terms of the extraction function YEAR( ) while the fragmentation dimension basis function f, (a)=a is a Datetime data type.

To address this situation, the transform processor 90 re-dimensions the data selection comparison-predicate of Equation (8) by substituting the argument of the YEAR( ) extraction on the left-hand side and an appropriate substitute Datetime constant on the right-hand side to produce the following fragment selection comparison-predicate:
a<Jan. 1, 2001 (9).

Because the re-dimensioned expression is less coarse (that is, has a higher resolution) there is no need to modify the exclusive inequality (“<”) comparison operator. Indeed, since the fragment selection expression can have a larger range than the data selection expression, the transform processor 90 could re-dimension the data selection expression of Equation (8) using another substitution for the right-hand side constant, such as:
a<Dec. 12, 2001 (10).

However, since the range of the fragment selection expression of Equation (10) is larger than the range of the fragment selection expression of Equation (9), the fragment selection expression of Equation (10) may fail to eliminate certain database fragments that would be eliminated using Equation (9) which has a smaller range that nonetheless is sufficient to encompass the range of the data selection expression.

As yet another example, the data selection comparison-predicate:
YEAR(a)≦2001 (11),

can be transformed to conform with a basis function f₁(a)=a by taking the argument of the YEAR( ) to yield the following fragment selection comparison-predicate:
a≦Dec. 31, 2001 (12).

Here, the constant “2001” must be transformed to the last day of year 2001, that is, to Dec. 31, 2001 (or a later date, such as Jan. 1, 2002), to ensure that the range of the fragment selection comparison-predicate of Equation (12) defines a range at least as large as the range of the source data selection comparison-predicate of Equation (11). For example, substituting “Jun. 1, 2001” for “2001” in the transform would be improper because certain values of the database field “a”, such as “Oct. 1, 2001”, would satisfy the data selection expression of Equation (11) but would not satisfy a fragment selection expression employing the endpoint constant “Jun. 1, 2001”.

While in the above examples, operation of the transform processor 90 has been described with reference to the SQL Datetime data type and the YEAR( ) extraction function, it will be appreciated that similar dimension corrections can be performed for other data types. To ensure a single-valued transformed function, the transform should be a monotonic transform. In the case of the Datetime data type, a MONTH( ) extraction is not a monotonic transform as applied to a Datetime value, since for example MONTH(Jun. 1, 2000)=MONTH(Jun. 1, 2001). Moreover, it is to be appreciated that monotonic functions other than extractions can be employed. For example, transformations x→log(x) or log(x)→x, where log( ) represents the common logarithm function, can be processed using the techniques described herein.

As an example of a complex data type other than Datetime, consider a contemplated complex data type Length with associated monotonic extraction function METER( ) which extracts the number of whole meters in the Length value. Consider a fragmentation dimension basis function f₁(a)=METER(a) where the database field “a” is a Length data type. The following data selection comparison-predicate:
a>3.5 (13)

can be transformed by the transform processor 90 to provide a fragment selection comparison-predicate:
METER(a)≧3 (14),

where the exclusive inequality (“>”) comparison operator of the data selection comparison-predicate of Equation (13) is replaced by corresponding inclusive inequality (“≧”) comparison operator to account for the coarsened granularity of the METER( ) extraction function versus the Length data type. Other examples of data types which can be expressed or measured using different granularities include weight (measured, for example in English units of pounds and ounces having different granularities, or in metric units of milligrams, grams, kilograms, etc., each having a different granularity), volume (measured, for example, in cubic meters and cubic feet, which have different granularities), and so forth. Moreover, different units having different granularities can be similarly processed. For example, the Length data type can have an associated METER( ) extraction providing the number of whole meters of the Length value, and also an associated FEET( ) extraction providing the number of whole feet in the Length value. A transform from, for example, a data selection expression including a METER(a) term (where a in this example is a database field of Length data type) to match a fragmentation dimension basis function f₁(a)=FEET(a) is readily accomplished using transformation techniques described herein taking into account the granularity difference between METER( ) and FEET( ).

In another example, a fragmented database is defined by the following SQL expression snippet:
Create table . . . fragment by . . .
   YEAR(sold-on)>2003 and Interval(Dec. 25, 2003-sold-on)<30) in fragment NearChristmas03
   YEAR(sold-on)>2003 and Interval(Dec. 25, 2003-sold-on)>30) in fragment NotNearChristmas03 (15)

The database created by the SQL snippet of Equation (15) has a fragmentation scheme including two fragmentation dimension basis functions. The first fragmentation dimension basis function is the function YEAR(sold-on). The second fragmentation dimension is the function Interval(Dec. 25, 2003-sold-on). Both of these basis functions depend upon a single database field, namely “sold-on”. Queries processed against the database of Equation (15) can employ fragment elimination if the data selection expression of the query includes comparison-predicates YEAR(sold-on), Interval(Dec. 25, 2003-sold-on), or another comparison-predicate that can be transformed into one of these basis functions using a monotonic transform. Consider, for example, a query having the following data selection expression:
Interval(Dec. 25, 2003-sold-on)>50 AND YEAR(sold-on)>2000 (16).

Since this data selection expression is a conjunction of simple comparison-predicates involving the fragmentation dimension basis functions, the fragment selection comparison-predicates processor constructs a fragment selection expression including those simple expressions:
YEAR(sold-on)>2000 AND Interval(Dec. 25, 2003-sold-on)>50 (17),

where the expression tree manipulator 50 reordered the expressions to match a selected ordering, but the data selection expression of Equation (16) is otherwise unchanged.

In another fragment elimination example using the database of Equation (15), a query having a data selection expression including the comparison-predicate sold-on>Dec. 12, 2004 is readily processed to produce a fragment selection comparison-predicate by applying the YEAR( ) extraction operator to both sides of the exclusive inequality (“>”) and replacing the exclusive inequality by an inclusive inequality (“≧”) to produce a fragment selection comparison-predicate YEAR(sold-on)≧2004. This fragment selection comparison-predicate is applied against the YEAR(sold-on) fragmentation dimension basis function comparison-predicates of the database fragmentation expressions.

Additionally, another fragment selection expression can be constructed from the data selection comparison-predicate sold-on>Dec. 12, 2004 which is directed toward the Interval(Dec. 25, 2003-sold-on) fragmentation dimension basis function. To do so, the transform processor 90 transforms both sides of the inequality using the transform x→Interval(Dec. 25, 2003−x) to produce a second fragment selection comparison-predicate Interval(Dec. 25, 2003-sold-on)>Interval(Dec. 25, 2003-Dec. 12, 2004). This second fragment selection expression is applied against the Interval(Dec. 25, 2003-sold-on) fragmentation dimension basis function comparison-predicates of the database fragmentation expressions.

It will be appreciated that by performing fragment elimination on both fragmentation dimensions YEAR(sold-on) and Interval(Dec. 25, 2003-sold-on) using suitable transformations of the query data selection expression sold-on>Dec. 12, 2004, more database fragments potentially may be eliminated versus performing fragment elimination on only one or the other of the two fragmentation dimensions. To maximize the fragment elimination, the two fragment elimination comparison-predicates derived from the same data selection comparison-predicate are preferably conjunctively combined in the fragment selection expression.

As yet another example, a fragmented database is defined by the following SQL expression snippet:
Create table . . . fragment by . . .
   sold-on>Dec. 31, 2003 and sold-on<=Dec. 31, 2004 in fragment 2004 (18).

This database has a fragmentation scheme employing a single dimension, namely sold-on, which has the Datetime data type. The database fragmentation expression in the snippet of Equation (18) defines a database fragment range of (Dec. 31, 2003, Dec. 31, 2004). Consider a query having a data selection expression with the comparison-predicate YEAR(sold-on)=2000. The transform processor 90 suitably converts from the coarse dimension YEAR( ) to the less coarse Datetime data type by removing the YEAR( ) extraction function from the left-hand side of the inequality and substituting an equivalent Datetime fragment selection range [Jan. 1, 2000,Dec. 31, 2000] for the argument “2000” corresponding to the fragmentation dimension basis function sold-on. Expressing this substitution in an algebraic form yields a fragment selection expression:
sold-on≧Jan. 1, 2000 and sold-on≦Dec. 31, 2000 (19),

which defines the fragment selection comparison-predicate range [Jan. 1, 2000,Dec. 31, 2000] for the fragmentation dimension sold-on.

As still yet another example, consider a fragmentation dimension basis function:
f₁(a)=100−a (20),

where the database field “a” is a numeric quantity. If the data selection expression of the query 40 includes the comparison-predicate:
a>90 (21),

this comparison-predicate is suitably transformed by the transform processor 90 into a comparison with the basis function f₁(a) by applying the transform x→(100−x) to both sides of the comparison-predicate to yield the fragment selection comparison-predicate:
f₁(a)<10 (22).

It will be noted that the greater-than comparison operator (“>”) of the data selection comparison-predicate of Equation (21) is replaced by the less-than comparison operator (“<”) in the fragment selection comparison-predicate of Equation (22). This comparison operator replacement is appropriate because the transform x→(100−x) is a monotonically decreasing transform. Generally, when a monotonically decreasing transform is applied, the directionality of the comparison operator should be reversed in the transformed comparison-predicate. It will also be noted that since the transform x→(100−x) does not change granularity, the exclusive less-than operator (“<”) is used.

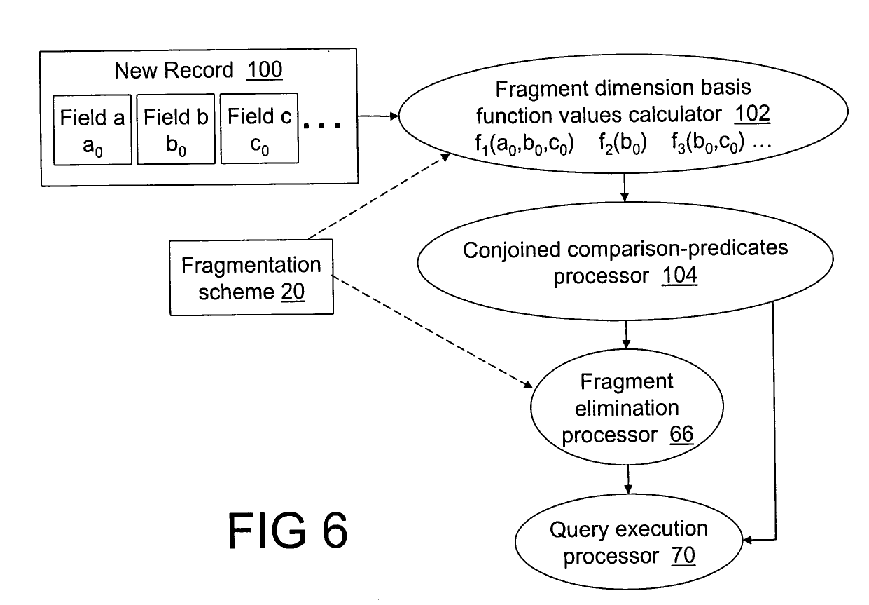

With reference to FIG. 6, processing of an example Row_Insert or Row_Update operation is described. The specific operation to be performed is to insert the new record 100 containing a value a₀ for database field “a”, a value b₀ for database field “b”, a value c₀ for database field “c”, and so forth, into the fragmented database. (Alternatively, in a Row_Update operation, the record 100 could contain update data a₀, b₀, c₀ . . . for updating an existing database record). A fragment dimension basis function values calculator 102 computes a value for each fragmentation dimension basis function, such as the example functions f₁(a,b,c)=f₁(a₀, b₀,c₀), f₂(b)=f₂(b₀), f₃(b,c)=f₃(b₀,c₀), . . . . A conjoined comparison-predicates processor 104 constructs a suitable data selection expression for the record 100 using the basis function values output by the fragment dimension basis function values calculator 102. In the present example, a suitable data selection expression is:
(f₁(a,b,c)=f₁(a₀, b₀,c₀))●(f₂(b)=f₂(b₀))●(f₃(b,c)=f₃(b₀,c₀))● (23),

where the data selection expression is constructed by conjoining comparison-predicates in which each comparison-predicate includes an equality comparison operator (“=”) comparing the basis function with its value calculated by the fragment dimension basis function values calculator 102. The constructed data selection expression also corresponds to a fragment selection expression, since it includes only simple comparisons of fragmentation dimension basis functions. Hence, the constructed expression is applied by the fragment elimination processor 66 to eliminate database fragments in the usual manner. Since the database fragments are preferably mutually exclusive in that any record satisfies the fragmentation expression of only a single database fragment, the fragment elimination performed by the fragment elimination processor 66 should eliminate all database fragments except that database fragment whose fragmentation expression is satisfied by the new record 100. The query execution processor 70 processes the query against that singular target database fragment to perform the Row_Insert or Row_Update operation.

The fragment elimination techniques described herein, and their equivalents, can be implemented by manipulation of algebraic comparison-predicates or internal representations thereof, and/or by manipulation of ranges equivalent to those comparison-predicates. Most of the examples herein employ algebraic formulations of the comparison-predicates which are manipulated by the expression tree manipulator 50 or similar components. However, the fragment elimination techniques described herein and their equivalents can also be implemented by manipulating the comparison-predicates in the form of ranges. Those skilled in the art can readily implement the fragment elimination techniques described herein using range-based processing. The choice of using algebraic or range processing, or some combination thereof, in a specific database fragment elimination processor depends upon engineering considerations. Moreover, it will be appreciated that a combination of algebraic and range-based manipulations can be employed in a specific implementation.

The processes, processors, and other components described herein are typically implemented using one or more computer programs, each of which executes under the control of an operating system, such as OS/2, Windows, DOS, AIX, UNIX, MVS, or so forth, and causes a computer to perform the desired processes as described herein. Thus, using the present specification, the disclosed apparatuses and methods may be implemented as a machine, process, or article of manufacture by using standard programming and/or engineering techniques to produce software, firmware, hardware or any combination thereof.

Generally, the computer programs are suitably tangibly embodied in one or more computer-readable devices or media, such as memory, data storage devices, and/or data communications devices, thus making a computer program product or article of manufacture embodiment. Moreover, the computer programs are comprised of instructions which, when read and executed by one or more computers, cause said computer or computers to perform operations to implement the programmed processes. Under control of the operating system, the computer programs may be loaded from the memory, data storage devices, and/or data communications devices into the memories of said computer or computers for use during actual operations. Those skilled in the art will recognize many modifications may be made to these example embodiments without departing from the scope of the present invention.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A method comprising:
fragmenting a database into a plurality of database fragments using a plurality of fragmentation expressions, each fragmentation expression corresponding to a database fragment and including a boolean combination of one or more comparison-predicates wherein each comparison-predicate defines a range of a fragmentation dimension basis function of one or more database fields; and
processing a database query against the database fragments of the database.

2. The method as set forth in claim 1, wherein the processing of a database query comprises:
resolving a data selection expression of the database query into a boolean combination of fragment selection comparison-predicates wherein each fragment selection comparison-predicate defines a range of one of the fragmentation dimension basis functions;
identifying one or more eliminated database fragments based on the boolean combination of fragment selection comparison-predicates and the fragmentation scheme; and
processing the database query against database fragments other than the eliminated database fragments.

3. The method as set forth in claim 2, wherein the resolving of the data selection expression into a boolean combination of fragment selection comparison-predicates comprises:
identifying a comparison-predicate of the data selection expression, the comparison-predicate including a comparison operator comparing a constant value with a candidate function that depends upon one or more database fields; and
converting the identified comparison-predicate into one or more of the fragment selection comparison-predicates.

4. The method as set forth in claim 3, wherein the converting comprises:
identifying the selected candidate function as equivalent to one of the fragmentation dimension basis functions.

5. The method as set forth in claim 3, wherein the converting comprises:
applying a monotonic transform to the candidate function and to the constant value of a identified comparison-predicate, the application of the monotonic transform converting the candidate function into one of the fragmentation dimension basis functions.

6. The method as set forth in claim 5, wherein the applying of a monotonic transform comprises:
applying an extraction function to the candidate function and to the constant value of the identified comparison-predicate.

7. The method as set forth in claim 6, wherein applying the extraction function increases granularity, the comparison operator of the identified comparison-predicate is an exclusive comparison operator, and the converting further comprises:
replacing the exclusive comparison operator with an inclusive comparison operator.

8. The method as set forth in claim 5, wherein the candidate function of the identified comparison-predicate is an extraction of one of the fragmentation dimension basis functions, and the applying of a monotonic transform comprises:
substituting the fragmentation dimension basis function for the candidate function of the identified comparison-predicate; and
substituting a new value for the constant value of the identified comparison-predicate, the extraction applied to the new value producing the constant value.

9. The method as set forth in claim 5, wherein the applying of a monotonic transform includes:
applying a monotonic transform that changes granularity; and
selecting an endpoint of a range of the transformed identified comparison-predicate to ensure that the range of the transformed identified comparison-predicate includes the entire range of the identified comparison-predicate.

10. The method as set forth in claim 5, wherein the applying of a monotonic transform includes:
applying a monotonically decreasing transform to the candidate function and to the constant value of the identified comparison-predicate; and
reversing a directionality of the comparison operator of the identified comparison-predicate.

11. The method as set forth in claim 3, wherein the converting of the identified comparison-predicate into one or more of the fragment selection comparison-predicates includes:
converting the identified comparison-predicate into a fragment selection comparison-predicate having a range that (i) is larger than the range of the identified comparison-predicate and (ii) includes the range of the identified comparison-predicate.

12. The method as set forth in claim 3, wherein the converting of the identified comparison-predicate into one or more of the fragment selection comparison-predicates includes:
converting the identified comparison-predicate into a fragment selection comparison-predicate having a smaller granularity than the identified comparison-predicate, an endpoint of the range defined by the fragment selection comparison-predicate being selected to include the entire range of the identified comparison-predicate.

13. The method as set forth in claim 1, wherein the processing of a database query comprises:
recognizing the query as a row insert or row update operation including a plurality of new record fields corresponding to database fields of the database;
computing fragmentation dimension values corresponding to the fragmentation dimension basis functions using the new record fields as inputs;
inserting or updating using the new record fields in an identified one of the database fragments whose corresponding fragmentation expression is satisfied by the computed fragmentation dimension values.

14. A fragmented database comprising:
a fragmentation scheme including:
(i) one or more fragmentation dimension basis functions wherein each fragmentation dimension basis function depends upon one or more database fields, and
(ii) a plurality of fragmentation expressions, each fragmentation expression being defined by a boolean combination of comparison-predicates wherein each comparison-predicate defines a range of one of the fragmentation dimension basis functions; and
a plurality of database fragments, each database fragment containing data satisfying a corresponding one of the plurality of fragmentation expressions.

15. the fragmented database as set forth in claim 14, further comprising:
a query processor performing a method including (i) receiving a database query and (ii) processing the database query against the plurality of database fragments; and
a fragment elimination processor performing a method including:
(i) resolving a data selection expression of the database query into a boolean combination of fragment selection comparison-predicates wherein each fragment selection comparison-predicate defines a range of one of the fragmentation dimension basis functions, and
(ii) eliminating one or more of the plurality of database fragments from the processing of the database query by the query processor, the eliminating being based on comparison of the boolean combination of fragment selection comparison-predicates with the fragmentation expressions.

16. The fragmented database as set forth in claim 14, wherein the one or more fragmentation dimension basis functions comprise:
a first fragmentation dimension basis function depending upon at least a first database field; and
a second fragmentation dimension basis function depending upon at least the first database field.

17. The fragmented database as set forth in claim 14, wherein the one or more fragmentation dimension basis functions comprise:
a fragmentation dimension basis function that depends upon at least two database fields.

18. The fragmented database as set forth in claim 14, wherein the one or more fragmentation dimension basis functions comprise:
a fragmentation dimension basis function that includes an extraction operator.

19. A storage medium encoding program code for performing database functions, the program code comprising:
program code for constructing a fragmented database having a fragmentation scheme constructed using fragmentation dimension basis functions, each fragmentation dimension basis function depending upon at least one database field; and
program code for inserting a new record into the fragmented database, the inserting including (i) computing values of the fragmentation dimension basis functions using fields of the new record, (ii) selecting a target database fragment based on the fragmentation scheme and the computed values of the fragmentation dimension basis functions, and (iii) inserting the new record into the target database fragment.

20. The storage medium as set forth in claim 19, wherein the program code further comprises:
program code for performing a database query, the performing including (i) resolving a data selection expression of the database query into one or more one-dimensional expressions each dimensioned by one of the fragmentation dimension basis functions, (ii) identifying at least one eliminated database fragment based on the one or more one-dimensional expressions and the fragmentation scheme, and (iii) processing the database query against the database fragments other than the at least one eliminated database fragment.
